(19) United States
(12) Patent Application Publication
(10) Pub. No.: US 2025/0023169 A1
(43) Pub. Date: Jan. 16, 2025

(54) COMPOSITE COVER FOR A BATTERY PACK OR A BATTERY MODULE FOR REDUCING THERMAL PROPAGATION RUNAWAY AND MITIGATING ARCING

(71) Applicant: GM Global Technology Operations LLC, Detroit, MI (US)

(72) Inventors: Venkateshwar R. AITHARAJU, Troy, MI (US); Xiaosong Huang, Novi, MI (US)

(21) Appl. No.: 18/352,031

(22) Filed: Jul. 13, 2023

(51) Int. Cl. H01M 50/229; H01M 10/658; H01M 50/224; H01M 50/231

(52) U.S. Cl. CPC H01M 50/229; H01M 10/658; H01M 50/224; H01M 50/231

(57) ABSTRACT

An enclosure for one of a battery module or battery pack includes a body configured to receive at least one of a plurality of battery modules and a plurality of battery cells. A cover is arranged over the body and includes an outer metallic layer, a composite layer arranged adjacent to an inner surface of the outer metallic layer and including reinforcing fibers encapsulated in resin, and a coating layer arranged on an inner surface of the composite layer and including a molecular nitrogen releasing agent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery enclosures, and more particularly to a composite battery cover for an enclosure of a battery pack or a battery module.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

An enclosure for one of a battery module or battery pack includes a body configured to receive at least one of a plurality of battery modules and a plurality of battery cells. A cover is arranged over the body and includes an outer metallic layer. A composite layer is arranged adjacent to an inner surface of the outer metallic layer and including reinforcing fibers encapsulated in resin. A coating layer is arranged on an inner surface of the composite layer and including a molecular nitrogen releasing agent.

In other features, a metallic mesh layer is arranged on an inner surface of the coating layer. The outer metallic layer comprises at least one of aluminum and steel. The at least one of aluminum and steel has a thickness in a range from 0.1 mm to 0.5 mm. The molecular nitrogen releasing agent is selected from a group consisting of polyurethane (PU), melamine, formaldehyde, benzoguanamines, isocyanurates, and combinations thereof. The molecular nitrogen releasing agent includes polyurethane, melamine, and formaldehyde.

In other features, the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester. The reinforcing fibers are selected from a group consisting of carbon fiber, glass fiber, basalt fiber, flax fiber, hemp fiber, pineapple fiber, cellulose fiber, aramid fibers, and natural fibers.

In other features, the resin includes a fire-retardant additive. The fire-retardant additive is selected from a group consisting of aluminum tetra hydrate (ATH), ammonium polyphosphate (APP), and expanding graphite (EG).

A system comprises the enclosure, S ultraviolet sensors arranged in the enclosure and configured to sense ultraviolet light intensity at S locations, where S is an integer greater than zero, and a controller configured to selectively detect arcing in response to the ultraviolet light intensity at the S locations.

An enclosure for one of a battery module or battery pack includes a body configured to receive at least one of a plurality of battery modules and a plurality of battery cells. A cover is arranged over the body and includes a metallic layer and a composite layer arranged adjacent to an inner surface of the metallic layer and including reinforcing fibers encapsulated in resin. The resin includes a molecular nitrogen releasing agent.

In other features, a metallic mesh layer is arranged on an inner surface of the composite layer. The metallic layer comprises at least one of aluminum and steel. The at least one of aluminum and steel has a thickness in a range from 0.1 mm to 0.5 mm. The molecular nitrogen releasing agent is selected from a group consisting of polyurethane (PU), melamine, formaldehyde, benzoguanamines, isocyanurates, and combinations thereof. The molecular nitrogen releasing agent includes polyurethane, melamine, and formaldehyde.

In other features, the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester. The reinforcing fibers are selected from a group consisting of carbon fiber, glass fiber, basalt fiber, flax fiber, hemp fiber, pineapple fiber, cellulose fiber, aramid fibers, and natural fibers.

In other features, the resin further includes a fire-retardant additive. The fire-retardant additive is selected from a group consisting of aluminum tetra hydrate (ATH), ammonium polyphosphate (APP), and expanding graphite (EG).

A system includes the enclosure, S ultraviolet sensors arranged in the enclosure and configured to sense ultraviolet light intensity at S locations, where S is an integer greater than zero, and a controller configured to selectively detect arcing in response to the ultraviolet light intensity at the S locations.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross sectional view of an example of a battery cell including cathode electrodes, anode electrodes, and separators arranged in a battery cell enclosure according to the present disclosure;

FIG. 1B is a side cross sectional view of an example of a battery pack including a plurality of battery modules each including a plurality of battery cells according to the present disclosure;

FIG. 2 is a side view of an example of a pouch battery cell according to the present disclosure;

FIG. 3 is a perspective view of an example of a prismatic battery cell according to the present disclosure;

FIG. 4 is a partial side cross section showing an example of a battery cover for a battery pack or a battery module including an outer metallic cover and a thermal blanket layer;

FIG. 5 is a side cross section of an example of a battery pack including an enclosure surrounding a plurality of battery modules and a controller configured to monitor arcing in the enclosure according to the present disclosure; and

FIGS. 6 and 7 are partial side cross sections showing examples of the battery covers for a battery pack or a battery module according to the present disclosure.

In the drawings, reference numbers may be reused to identify similar and/or identical elements.

### DETAILED DESCRIPTION

While enclosures for a battery pack or battery module according to the present disclosure are shown in the context of electric vehicles, the enclosures can be used in stationary applications and/or other applications.

A battery module includes a battery module enclosure and a plurality of battery cells arranged in the battery module enclosure. A battery pack includes a battery pack enclosure and a plurality of battery modules arranged in the battery pack enclosure. The enclosure for the battery module and/or battery pack may include a body and a cover.

When one of the battery cells and/or battery modules fails, the battery cell or battery module may have a thermal runaway event. Thermal runaway events are caused when the temperature of the battery cell or battery module increases. The increased temperature releases energy that further increases the temperature. If not extinguished, the battery cell or battery module undergoing the thermal runaway event may cause other adjacent battery cells or battery modules in the enclosure of the battery module or battery pack to experience increased temperature and further thermal runaway events (thermal runaway propagation (TRP)). Typically, the enclosure of the battery cell or battery module is sealed and may include air and/or vent gases generated by the electrodes. The enclosure of the battery cell or battery module may include a vent or pouch seam that bursts when pressure within the enclosure is greater than a predetermined vent pressure.

During the thermal runaway event, the pressure of vent gases in the battery cell enclosure, battery module, and/or battery pack increases. When the pressure of the vent gases is sufficiently high, the vent of the battery cell or battery module bursts to release the vent gases from the battery cell or battery module. In addition to vent gases, the battery cell or battery module may also produce ionic particles near the vent. If the ionic particles are created and have sufficient speed/energy and other conditions are met, the ionic particles may cause arcs to occur between the battery cell or battery module and adjacent conducting structures.

In some examples, an enclosure for the battery module and/or battery pack according to the present disclosure includes a body and a cover. The cover includes an outer metallic layer, a composite layer including resin and reinforcing fibers and a coating layer including a molecular nitrogen releasing agent. In some examples, a metallic mesh layer may be arranged on an inner surface of the coating layer. In some examples, the resin of the composite layer may also include a fire retardant additive.

The molecular nitrogen releasing agent of the inner coating layer releases molecular nitrogen during thermal decomposition. As noted above, the temperature inside of the enclosure of the battery module and/or battery pack increases during a thermal runaway event. The release of molecular nitrogen by the releasing agent during thermal decomposition of the coating layer creates a high dielectric medium during the thermal runaway event by increasing molecular nitrogen concentration in the enclosure of the battery module or battery pack. The increased molecular nitrogen concentration in the enclosure of the battery module or battery pack causes the ionic particles to move at a slower speed, which reduces the likelihood of arcs.

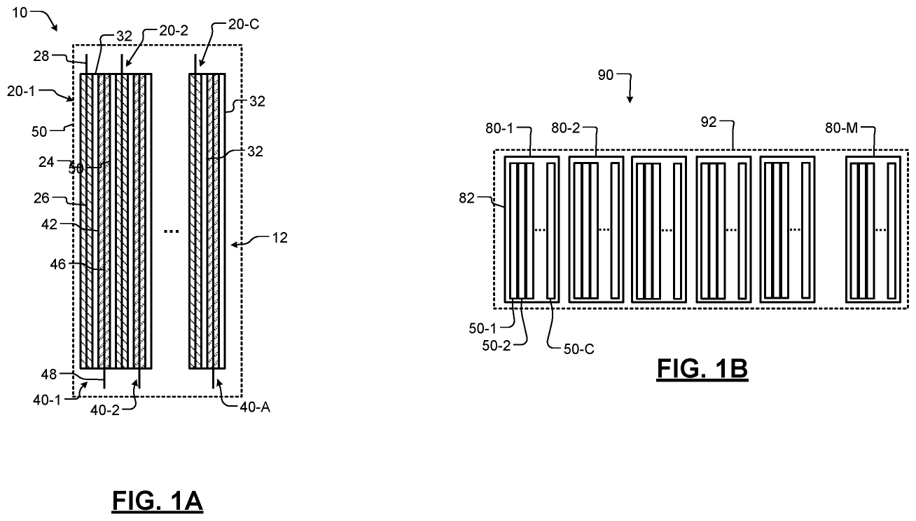

Referring now to FIG. 1, a battery cell 10 includes C cathode electrodes 20, A anode electrodes 40, and S separators 32 arranged in a predetermined sequence in a stack 12 arranged in a battery cell enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include anode active layers 42 arranged on one or both sides of the anode current collectors 46.

In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process. In some examples, the cathode current collectors 26 and the anode current collectors 46 comprise a foil layer. In some examples, the current collectors are made of one or more materials selected from a group consisting of copper, stainless steel, brass, bronze, zinc, aluminum, and alloys thereof.

In FIG. 1B, a battery pack 90 includes a battery pack enclosure 92 enclosing a plurality of battery modules 80-1, 80-2, . . . , and 80-M, where M is an integer greater than one. Each of the battery modules 80 includes a battery module enclosure 82 and a plurality of battery cell enclosures 50-1, 50-2, . . . , 50-C arranged in the battery module enclosure 82.

Referring now to FIG. 2, a pouch battery cell 52 includes a pouch enclosure 53 including a stack 56. External tabs 57 of the anode and cathode electrodes are connected to terminals 54 and 55, respectively, that extend through the pouch enclosure 53. During a thermal runaway event, the pouch enclosure 53 of the pouch battery cell 52 may burst at a seam and/or a vent (not shown) may be used.

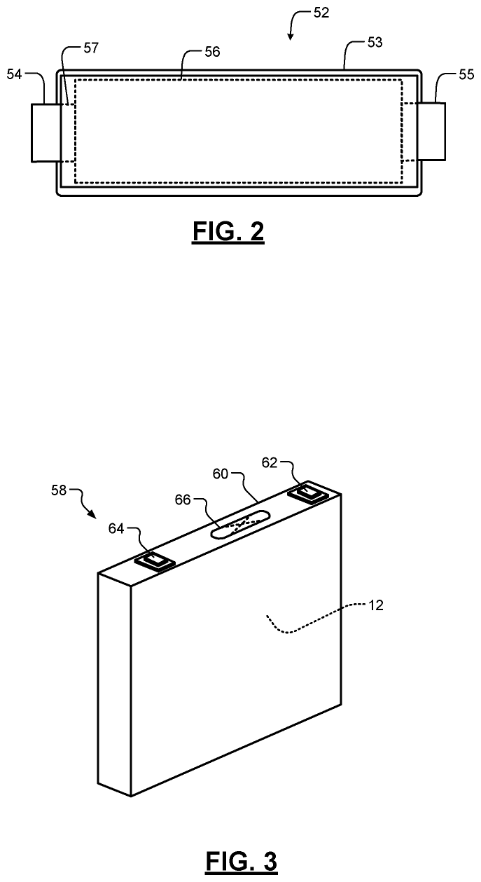

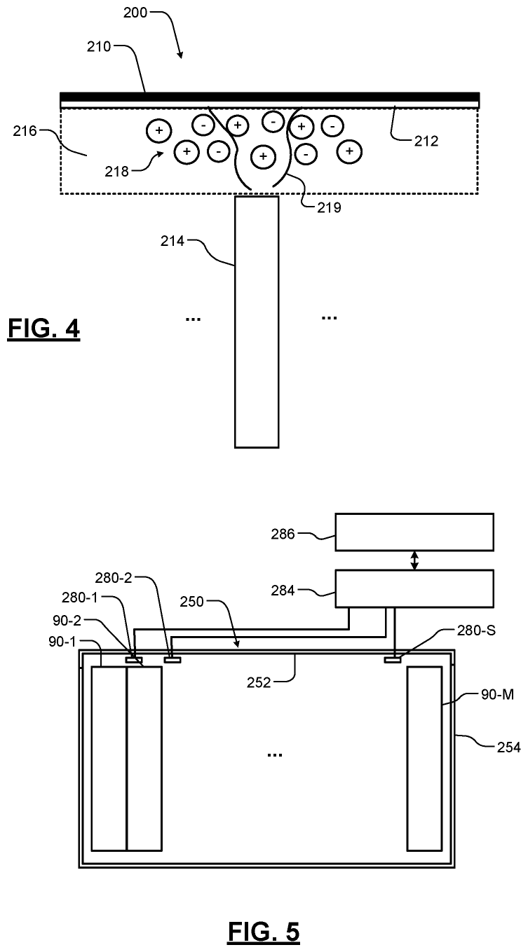

Referring now to FIG. 3, a prismatic battery cell 58 includes an enclosure 60. In some examples, the enclosure 60 has rectangular cross-sections in x-, y- and z-axis planes. The prismatic battery cell 58 includes external terminals 62 and 64 and a vent cap 66. The stack 12 of the C cathode electrodes 20, the A anode electrodes 40, and the S separators 32 is arranged in the enclosure 60. The external terminals 62 and 64 are connected to external tabs of the electrodes. While pouch and prismatic battery cells are shown, other form factors can be used.

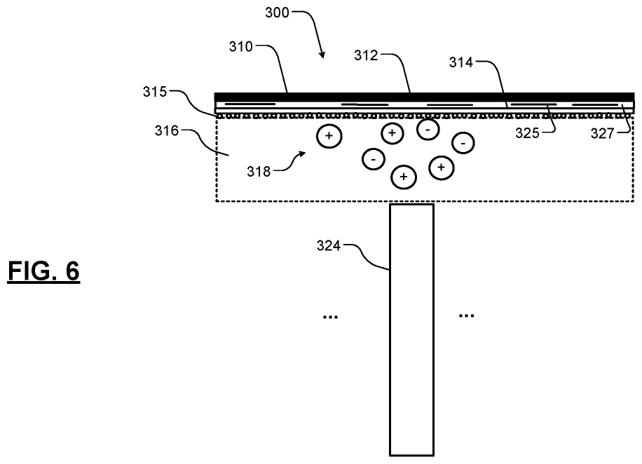

Referring now to FIG. 4, a battery cover 200 can be used for a battery pack enclosure that encloses a plurality of battery modules 214 (or for a battery module enclosure enclosing a plurality of battery cell enclosures). The battery cover 200 includes a metallic layer 210 and a thermal insulation layer 212 arranged on an inner surface of the metallic layer 210. As noted above, the battery cover 200 forms a sealed environment with the body that includes air and/or vent gases. During a thermal runaway event, the pressure of vent gases in one or more of the battery modules/cells may increase sufficiently to cause the vent of one of the battery modules/cells to burst. When the vent bursts, vent gases are released. Under certain conditions, the vent gases and heat that is produced by the thermal runaway event may generate ionic particles 218 and/or arcs 219 between the modules/cells and adjacent conducting structures such as the metallic layer 210.

The arc breakdown voltage V_{BD} can be estimated based on the following equation:

$${V}_{BD} = \frac{e * ln ( 1 + \frac{1}{{γ}_{se}} )}{A}$$

where A is a saturation ionization constant of the gas and γₛₑ is the secondary electron emission coefficient. Saturation ionization is the process by which a gas is ionized by a high energy electron. Example values of A for different gases include argon at 1.7×10⁻¹⁵/cm, helium at 5.0×10⁻¹⁶/cm, hydrogen at 2.2×10⁻/cm, and nitrogen at 1.7×10⁻¹⁷/cm. Example values of A include argon at 0.3 to 1.5 depending on electron energy and angle of incidence, helium at around 1.0 for electron energies between 100 eV and 5 keV, hydrogen at 0.5 for electron energies between 100 eV and 5 keV, oxygen at 1.0 for electron energies between 100 eV and 5 keV, and nitrogen at around 1.0 for electron energies between 100 eV and 5 keV.

Higher values of V_{BD} occur for lower values of A and γₛₑ. Increasing molecular nitrogen concentration effectively increases V_{BD}. Increasing the arc breakdown voltage V_{BD} reduces the likelihood of arcing.

As will be described further below, the enclosure of the battery module or battery pack according to the present disclosure releases nitrogen during thermal decomposition of the coating layer (e.g., during thermal runaway events). The increase in molecular nitrogen concentration in the atmosphere of the enclosure of the battery module or battery pack slows speed/energy of ionic particles and, as a result, reduces the likelihood of arcing.

Referring now to FIG. 5, an enclosure 250 for a battery module or a battery pack includes a cover 252 and a body 254 enclosed by the cover 252. The body 254 is configured to receive M battery modules 90-1, 90-2, . . . , and 90-M, where M is an integer greater than one. The cover 252 is arranged over the body 254. In some examples, the cover 252 and the body 254 are made of the same materials. In other examples, the cover 252 is made of different materials than the body 254.

In some examples, an enclosure 250 for a battery module or a battery pack includes S arc sensors 280-1, 280-2, . . . , and 280-S, where S is an integer greater than one. The S arc sensors 280-1, 280-2, . . . , and 280-S are arranged in the enclosure of the battery module or battery pack and are configured to sense ultraviolet light. Arcing produces ultraviolet light. The measured ultraviolet light concentration is compared to one or more predetermined thresholds, and an arc is selectively declared in response to the comparison. In some examples, the S arc sensors 280-1, 280-2, . . . , and 280-S comprise photodiodes.

In some examples, outputs of the S arc sensors 280-1, 280-2, . . . , and 280-S are received by a controller 284 that is configured to compare the measured intensity of the ultraviolet light to one or more predetermined thresholds, and selectively declare that an arc has occurred in a location near the corresponding sensor in response to the comparison.

In some examples, the controller 284 communicates with a propulsion controller 286. When the controller 284 detects arcing, the controller 284 sends a message to the propulsion controller 286. In some examples, the propulsion controller 286 adjusts one or more operating parameters of the battery system and/or electric motor(s) in response to the detection of the arcing. For example, the propulsion controller 286 may generate an audible or visual alert, send a message to a manufacturer of the electric vehicle via a telematics system, reduce power output, shutdown, increase cooling of the battery system, thermal runaway, or fire suppression systems, and/or take other mitigation actions.

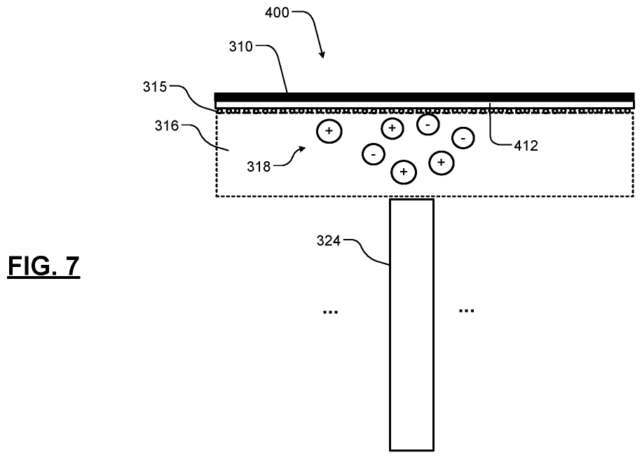

Referring now to FIG. 6, a cover 300 for the enclosure of the battery module or battery pack is shown. The cover 300 is arranged above vents of battery modules 324 (or battery cells). The cover 300 includes a metallic layer 310. A composite layer 312 is arranged inside of the metallic layer 310. A coating layer 314 including a molecular nitrogen releasing agent is arranged on an inner surface of the composite layer 312. A metallic mesh layer 315 is arranged on an inner surface of the coating layer 314 to create a cage inside the enclosure of the battery module or battery pack to confine, distort, and/or destabilize the arc during thermal runaway events.

In some examples, the metallic layer 310 includes a metal sheet. In some examples, the metal sheet includes an aluminum sheet or a steel sheet having a thickness in a range from 0.1 mm to 0.5 mm (e.g., 0.2 mm), although other materials and thicknesses may be used. In some examples, the metallic layer 310 is co-molded with or bonded to the composite cover after molding using resin transfer molding or compression molding. During a thermal runaway event, the increased heat causes the metallic layer 310 to delaminate from the composite layer 312 to create an air gap between the composite layer 312 and the metallic layer 310. The air gap creates a thermal barrier.

In some examples, the coating layer 314 includes a molecular nitrogen releasing agent that releases molecular nitrogen during thermal decomposition. In some examples, the molecular nitrogen releasing agent is selected from a group consisting of polyurethane (PU), melamine, formaldehyde, benzoguanamines, isocyanurates, and combinations thereof. In some examples, the coating layer 314 includes polyurethane, melamine, and formaldehyde.

In some examples, the composite layer 312 includes reinforcing fibers 325 encapsulated in resin 327. In some examples, the resin is also mixed with a fire-retardant additive. In some examples, the fire-retardant additive is selected from a group consisting of aluminum tetra hydrate (ATH), ammonium polyphosphate (APP), and expanding graphite (EG). EG is an intumescent material. Intumescent materials swell in response to heat exposure, which leads to an increase in volume and a decrease in density. During thermal runaway events, the coating layer 314 releases molecular nitrogen in the enclosure of the battery module or battery pack.

Referring now to FIG. 7, a cover 400 encloses the plurality of battery modules (or battery cells). The cover 400 includes the metallic layer 310. A composite layer 412 is arranged inside of the metallic layer 310. The metallic mesh layer 315 is arranged on an inner surface of the coating layer 314. In some examples, the composite layer 412 includes resin and reinforcing fibers. In some examples, the resin of the composite layer 412 is also mixed with the molecular nitrogen releasing agent. In some examples, the resin of the composite layer 412 is also mixed with the fire retardant.

In some examples, the metallic mesh layer 315 includes a plurality of first wires arranged parallel to one another and extending in a first direction and a plurality of second wires arranged parallel to one another and extending in a second direction that is different than the first direction. The plurality of first wires are interwoven with the plurality of second wires to create an array of mesh joints. In some examples, the first and second directions are transverse, although other angles can be used. In some examples, the metallic mesh layer 315 is made of a material selected from a group consisting of copper, steel, aluminum, nickel, stainless steel, or other suitable metal.

In some examples, the reinforcing fibers can include continuous and/or discontinuous fibers. The reinforcing fibers can include one or more fibers selected from a group consisting of carbon fiber, glass fiber, basalt fiber, flax fiber, hemp fiber, pineapple fiber, cellulose fiber, aramid fibers, natural fibers, or other suitable fibers. In other features, the reinforcing fibers include commingled fibers. For example, the commingled fibers include first fibers (selected from a group consisting of carbon, glass, basalt, flax, hemp, pineapple, and cellulose) that are commingled with second fibers selected from a group consisting of polycarbonate, nylon, polyetheretherketone (PEEK), polyetherimide (PEI), polyphenylene sulfide (PPS), polyester, polyethylene, and polypropylene)).

In some examples, the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester, and/or other transparent polymer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An enclosure for one of a battery module or battery pack, comprising:
a body configured to receive at least one of a plurality of battery modules and a plurality of battery cells; and
a cover arranged over the body and including:
an outer metallic layer;
a composite layer arranged adjacent to an inner surface of the outer metallic layer and including reinforcing fibers encapsulated in resin; and
a coating layer arranged on an inner surface of the composite layer and including a molecular nitrogen releasing agent.

2. The enclosure of claim 1, further comprising a metallic mesh layer arranged on an inner surface of the coating layer.

3. The enclosure of claim 1, wherein the outer metallic layer comprises at least one of steel and aluminum.

4. The enclosure of claim 3, wherein the at least one of steel and aluminum has a thickness in a range from 0.1 mm to 0.5 mm.

5. The enclosure of claim 1, wherein the molecular nitrogen releasing agent is selected from a group consisting of polyurethane (PU), melamine, formaldehyde, benzoguanamines, isocyanurates, and combinations thereof.

6. The enclosure of claim 1, wherein the molecular nitrogen releasing agent includes polyurethane, melamine, and formaldehyde.

7. The enclosure of claim 1, wherein:
the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester, and
the reinforcing fibers are selected from a group consisting of carbon fiber, glass fiber, basalt fiber, flax fiber, hemp fiber, pineapple fiber, cellulose fiber, aramid fibers, and natural fibers.

8. The enclosure of claim 1, wherein the resin includes a fire-retardant additive.

9. The enclosure of claim 8, wherein the fire-retardant additive is selected from a group consisting of aluminum tetra hydrate (ATH), ammonium polyphosphate (APP), and expanding graphite (EG).

10. A system comprising:
the enclosure of claim 1;
S ultraviolet sensors arranged in the enclosure and configured to sense ultraviolet light intensity at S locations, where S is an integer greater than zero; and
a controller configured to selectively detect arcing in response to the ultraviolet light intensity at the S locations.

11. An enclosure for one of a battery module or battery pack, comprising:
a body configured to receive at least one of a plurality of battery modules and a plurality of battery cells; and
a cover arranged over the body and including:
a metallic layer; and
a composite layer arranged adjacent to an inner surface of the metallic layer and including reinforcing fibers encapsulated in resin;
wherein the resin includes a molecular nitrogen releasing agent.

12. The enclosure of claim 11, further comprising a metallic mesh layer arranged on an inner surface of the composite layer.

13. The enclosure of claim 11, wherein the metallic layer comprises at least one of aluminum and steel.

14. The enclosure of claim 13, wherein the at least one of aluminum and steel has a thickness in a range from 0.1 mm to 0.5 mm.

15. The enclosure of claim 11, wherein the molecular nitrogen releasing agent is selected from a group consisting of polyurethane (PU), melamine, formaldehyde, benzoguanamines, isocyanurates, and combinations thereof.

16. The enclosure of claim 11, wherein the molecular nitrogen releasing agent includes polyurethane, melamine, and formaldehyde.

17. The enclosure of claim 11, wherein:
the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester, and
the reinforcing fibers are selected from a group consisting of carbon fiber, glass fiber, basalt fiber, flax fiber, hemp fiber, pineapple fiber, cellulose fiber, aramid fibers, and natural fibers.

18. The enclosure of claim 11, wherein the resin further includes a fire-retardant additive.

19. The enclosure of claim 18, wherein the fire-retardant additive is selected from a group consisting of aluminum tetra hydrate (ATH), ammonium polyphosphate (APP), and expanding graphite (EG).

20. A system comprising:
the enclosure of claim 11;
S ultraviolet sensors arranged in the enclosure and configured to sense ultraviolet light intensity at S locations, where S is an integer greater than zero; and
a controller configured to selectively detect arcing in response to the ultraviolet light intensity at the S locations.
